(19) United States
(12) Patent Application Publication
(10) Pub. No.: US 2013/0270315 A1
(43) Pub. Date: Oct. 17, 2013

(54) Adaptable bottle cage for a bicycle

(71) Applicant: Szu-Fang Tsai, Changhua (TW)

(72) Inventor: Szu-Fang Tsai, Changhua (TW)

(21) Appl. No.: 13/443,975

(22) Filed: Apr. 11, 2012

(51) Int. Cl. B62J 11/00

(52) U.S. Cl. 224/414

(57) ABSTRACT

An adaptable bottle cage attachable to a frame tube of a bicycle is provided with a clip including a hanging plate and two parallel latching arms; a bracket including an upper aperture, a lower aperture, and two intermediate studs releasably secured to the hanging plate; a support integrally formed with a bottom end of the bracket; a first curved strut having a bottom end integrally formed with one end of the support distal the bracket and a top end integrally formed with one of two sides of the bracket; and a second curved strut having a bottom end integrally formed with one end of the support distal the bracket and a top end integrally formed with the other side of the bracket. The bottle cage can hold one of different water bottles with various sizes in position.

### BACKGROUND OF THE INVENTION

1. Field of the Invention

The invention relates to accessories mountable on the frame of a bicycle and more particularly to a bottle cage attachable to a frame tube of a bicycle and the bottle cage being adapted to hold one of different water bottles with various sizes.

2. Description of Related Art

Bottle holder or cage attachable to a frame tube (e.g., down tube) of a bicycle is well known. However, as far as the present inventor is aware, none of the disclosed patents is adapted to hold one of different water bottles with various sizes, i.e., conventional bottle cages or holders for a bicycle being designed to hold a bottle of default size.

Thus, the need for providing a bottle cage adaptable to hold one of different water bottles with various sizes exists.

### SUMMARY OF THE INVENTION

It is therefore one object of the invention to provide a cage comprising a clip comprising a hanging plate and two parallel latching arms; a bracket comprising an upper aperture, a lower aperture, and two intermediate studs releasably secured to the hanging plate; a support integrally formed with a bottom end of the bracket; a first curved strut having a bottom end integrally formed with one end of the support distal the bracket and a top end integrally formed with one of two sides of the bracket; and a second curved strut having a bottom end integrally formed with one end of the support distal the bracket and a top end integrally formed with the other side of the bracket.

The above and other objects, features and advantages of the invention will become apparent from the following detailed description taken with the accompanying drawings.

### BRIEF DESCRIPTION OF THE DRAWINGS

FIG. 1 is an exploded view of an adaptable bottle cage for a bicycle according to the invention;

FIG. 2 is a perspective view of the assembled bottle cage;

FIG. 3 is a side elevation in part section of the bottle cage of FIG. 2;

FIG. 4 is a view similar to FIG. 3 showing a first water bottle held in position in the bottle cage;

FIG. 5 is a perspective view of a second water bottle held in position in the bottle cage;

FIG. 6 is a view similar to FIG. 3 showing a third water bottle held in position in the bottle cage; and

FIG. 7 is a perspective view of FIG. 6.

### DETAILED DESCRIPTION OF THE INVENTION

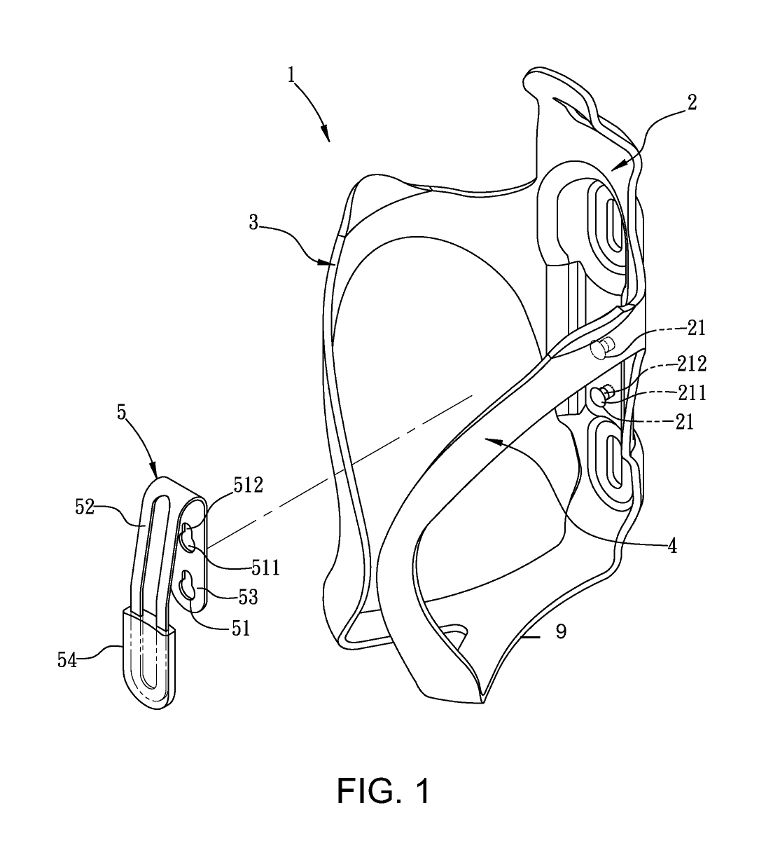

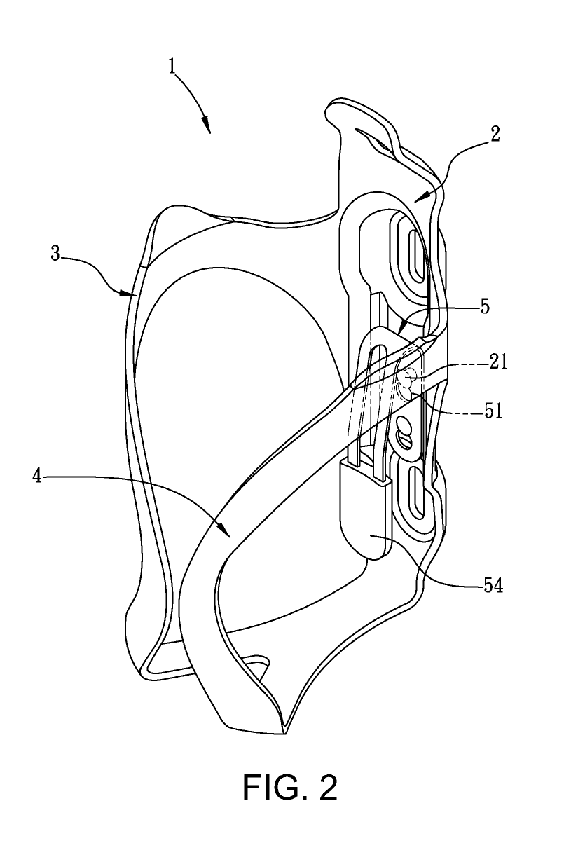

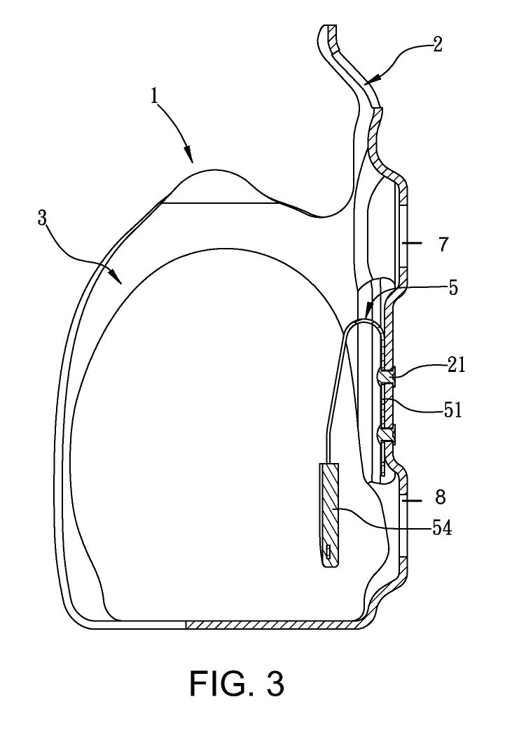

Referring to FIGS. 1 to 7, an adaptable bottle cage 1 for a bicycle in accordance with the invention comprises the following components as discussed in detail below. The cage 1 is preferably formed of flexible material (e.g., plastic or metal).

An elongated bracket 2 is of substantially rectangular and comprises an upper aperture 7, a lower aperture 8, and two intermediate studs 21 on one surface, each stud 21 including a shaft 212 and an enlarged head 211 at an end of the shaft 212.

A support 9 is integrally formed with a bottom end of the bracket 2. A first curved strut 3 has a bottom end integrally formed with one end of the support 9 distal the bracket 2 and a top end integrally formed with one side of the bracket 2 adjacent to the upper aperture 7 and the studs 21. A second curved strut 4 has a bottom end integrally formed with one end of the support 9 distal the bracket 2 and a top end integrally formed with the other side of the bracket 2 adjacent to the upper aperture 7 and the studs 21.

A bent clip 5 comprises a hanging plate 53, two overlapping members 51 each including a circular holed portion 511 and a slot portion 512, two parallel latching arms 52 integrally formed with the hanging plate 53, and an engaging member 54 disposed at one ends of the latching arms 52.

The circular holed portion 511 has a diameter slightly greater than that of the head 211 of the stud 21. The width of the slot portion 512 is less than the diameter of the circular holed portion 511. The width of the slot portion 512 is slightly less than the diameter of the shaft 212. The distance between centers of the circular holed portions 511 is equal to centers of the heads 211.

In assembly, an individual may pass the circular holed portions 511 through the heads 211 and after passing, push the hanging plate 53 downward to move the slot portions 512 relative to the shafts 212 until one ends of the slot portions 512 are stopped by the shafts 212. As a result, the clip 5 is releasably secured to the studs 21. Moreover, a first threaded fastener (e.g., screw) (not shown) can be driven through the upper aperture 7 into a frame tube (e.g., down tube) of a bicycle and a second threaded fastener (e.g., screw) (not shown) can be driven through the lower aperture 8 into the frame tube (e.g., down tube) of the bicycle respectively so as to secure the cage 1 to the frame tube of the bicycle.

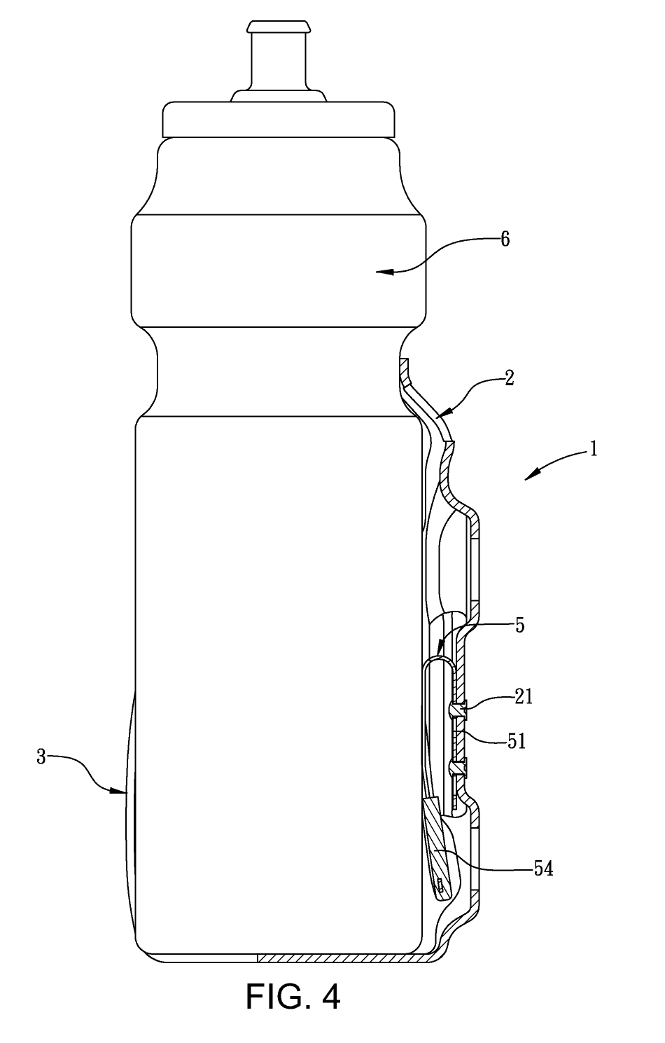

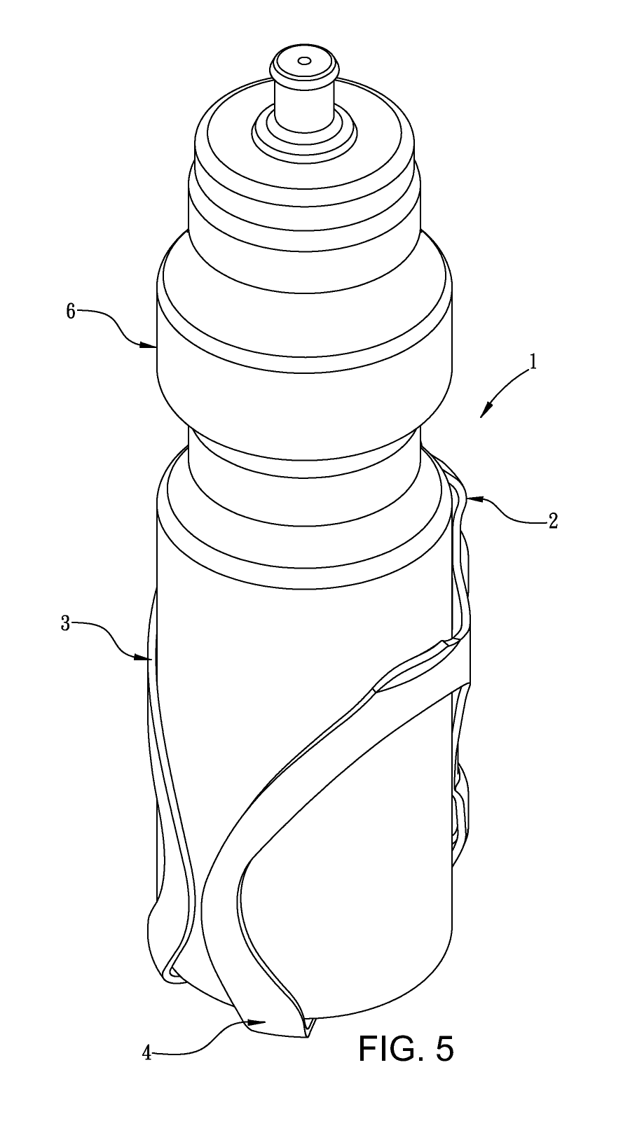

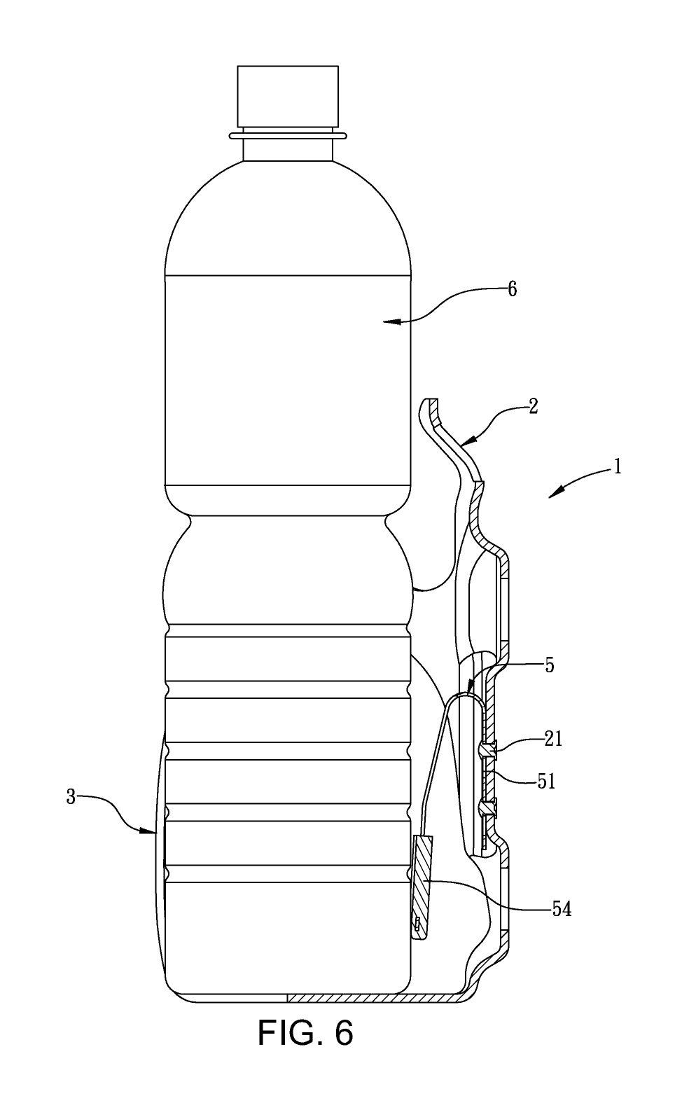

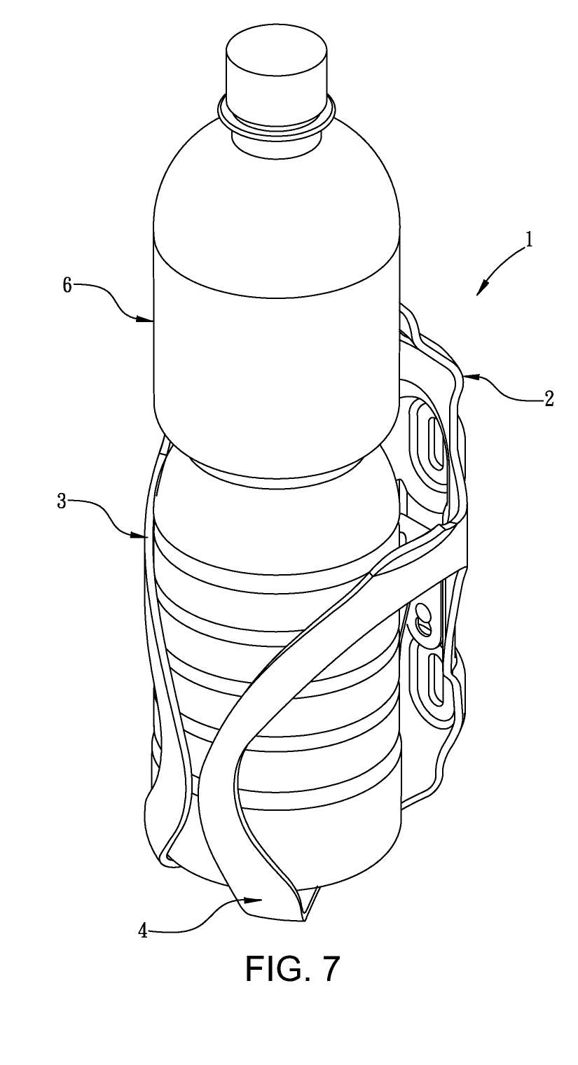

Referring to FIGS. 4 to 7 specifically, three preferred embodiments of the invention are shown. In FIG. 4, a water bottle 6 of a first size is inserted into a receiving space of the cage 1 supported by the support 9 with the latching arms 52 and the engaging member 54 urging against an outer surface of the water bottle 6. In FIG. 5, a water bottle 6 of a first size but having a different upper portion is inserted into the receiving space of the cage 1 supported by the support 9 with the latching arms 52 and the engaging member 54 urging against the outer surface of the water bottle 6. In FIGS. 6 and 7, a water bottle 6 of a second size, smaller than the water bottle 6 of the first size, is inserted into the receiving space of the cage 1 supported by the support 9 with the engaging member 54 urging against the outer surface of the water bottle 6.

While the invention has been described in terms of preferred embodiments, those skilled in the art will recognize that the invention can be practiced with modifications within the spirit and scope of the appended claims.

What is claimed is:

1. A cage comprising:
a clip comprising a hanging plate and two parallel latching arms;
a bracket comprising an upper aperture, a lower aperture, and two intermediate studs releasably secured to the hanging plate;
a support integrally formed with a bottom end of the bracket;
a first curved strut having a bottom end integrally formed with one end of the support distal the bracket and a top end integrally formed with one of two sides of the bracket; and
a second curved strut having a bottom end integrally formed with one end of the support distal the bracket and a top end integrally formed with the other side of the bracket.

2. The cage of claim 1, wherein each stud comprises a shaft and an enlarged head at an end of the shaft, wherein the hanging plate comprises two overlapping members each including a circular holed portion and a slot portion, and wherein the circular holed portion has a diameter slightly greater than that of the enlarged head of the stud, the slot portion has a width less than the diameter of the circular holed portion, the width of the slot portion is slightly less than a diameter of the shaft of the stud, and a distance between centers of the circular holed portions is equal to centers of the enlarged heads of the studs.

3. The cage of claim 1, wherein the clip is bent.

4. The cage of claim 1, wherein the clip further comprises an engaging member disposed at one ends of the latching arms.
